(19) United States
(12) Patent Application Publication
(10) Pub. No.: US 2014/0200964 A1
(43) Pub. Date: Jul. 17, 2014

(54) MULTI-PRODUCT PRICING MARKDOWN OPTIMIZER

(71) Applicant: ORACLE INTERNATIONAL CORPORATION, Redwood Shores, CA (US)

(72) Inventors: Anahita HASSANZADEH, Bethlehem, PA (US); Andrew VAKHUTINSKY, Norwood, MA (US); Kiran PANCHAMGAM, Woburn, MA (US)

(73) Assignee: ORACLE INTERNATIONAL CORPORATION, Redwood Shores, CA (US)

(21) Appl. No.: 13/741,817

(22) Filed: Jan. 15, 2013

(51) Int. Cl. G06Q 30/02

(52) U.S. Cl. 705/7.35

(57) ABSTRACT

A system that determines markdown pricing for a plurality of items over a plurality of time periods receives a non-linear time-dependent problem, where the non-linear time-dependent problem comprises a demand model. The system determines approximate inventory levels for each item in each time period and, for a plurality of pair of items in a product category, determines coefficients for a change in demand of a first product at each of the plurality of time periods when a price of a second product is changed using initial prices and initial approximate inventory levels. The system generates an approximate MILP problem comprising a change of demand based on a sum of the determined coefficients. The system then solves the MILP problem to generate revised prices and revised inventory levels. The functionality is repeated until a convergence criteria is satisfied, and then the system assigns the revised prices as the markdown product pricing.

### FIELD

One embodiment is directed generally to a computer system, and in particular to a computer system that optimizes product pricing.

### BACKGROUND INFORMATION

Product line pricing is an important business problem faced by retailers and other sellers of merchandise who employ dynamic pricing strategies to generate incremental revenue benefits throughout the year. Retailers, among others, have in increasing numbers begun to utilize decision support systems that leverage the large volume of detailed demand data to automate and optimize pricing recommendations. In particular, the statistical modeling of the price elasticity of items based on analyzing the effect of price changes of one product on its demand, or the demand for another product, can be used to optimize the pricing of products.

Known price optimizers, in general, are given a set of items in a product category together with their current prices and demand cross-elasticity. The optimizers then find a new set of prices that would satisfy all business rules and maximize the profit margin by taking into account some soft price constraints and allowed prices.

Some optimizers determine a product markdown optimization pricing. Markdown pricing is an essential part of the merchandise item lifecycle pricing. In general, a typical retailer has between 20% and 50% of the items marked down (i.e., permanently discounted). According to a survey, more than 72% of all fashion items sold were sold at an average discount of about 25%. Most of the European fashion retailers have 30-40% of their sales volume generated at marked-down prices.

The objective of a markdown optimization problem is to find a non-increasing sequence of merchandise prices to maximize the revenue subject to limited non-replenishable inventory, clearance period length, and demand dependency on price. Frequently, numerous business rules are imposed that make this problem even more challenging and complex even for a single product.

### SUMMARY

One embodiment is a system that determines markdown product pricing for a plurality of items over a plurality of time periods. The system receives a non-linear time-dependent problem, where the non-linear time-dependent problem comprises a demand model. The system determines approximate inventory levels for each item in each time period and, for a plurality of pair of items in a product category, determines coefficients for a change in demand of a first product at each of the plurality of time periods when a price of a second product is changed using initial prices and initial approximate inventory levels. The system generates an approximate Mixed Integer Linear Programming (“MILP”) problem comprising a change of demand based on a sum of the determined coefficients. The system then solves the MILP problem to generate revised prices and revised inventory levels.

When the generated revised prices and revised inventory levels do not satisfy a convergence criteria after the solving, the system repeats the determining coefficients, the generating the approximate MILP problem and the solving the MILP problem using the revised prices and the revised inventory levels as the initial prices and initial approximate inventory levels until the convergence criteria is satisfied. When the convergence criteria is satisfied, the system assigns the revised prices as the markdown product pricing.

### BRIEF DESCRIPTION OF THE DRAWINGS

FIG. 1 is a block diagram of a computer system that can implement an embodiment of the present invention.

FIG. 2 is a flow diagram of the functionality of the multi-product markdown pricing module of FIG. 1 when optimizing multi-product markdown pricing in accordance with one embodiment.

FIG. 3 is a graph of revenue versus run number for optimizers in accordance with embodiments.

FIGS. 4a and 4b are graphs showing the effect of inventory approximation on optimality and the quality of the inventory approximation, respectively, in accordance with embodiments.

### DETAILED DESCRIPTION

One embodiment solves the markdown optimization problem for multiple products. As compared to a single product optimizer, solving for multiple products is more difficult to solve due to cross-product price effects and markdown budget constraints. The former occurs when changing the price for one product affects demand for another. The latter imposes limits on how much the entire on-hand merchandise inventory can be discounted.

One embodiment uses time-dependent merchandise prices as the decision variables. Embodiments assume that the prices can be changes on a periodic basis (e.g., weekly) and are taken from a given discreet set of prices, referred to as a “price ladder.” For example, prices may be required to end only with 0.99 cents. Embodiments in general utilize an objective function that is non-linear and time-dependent. In general, and in accordance with embodiments of the present invention, a time-dependent price optimization problem can be stated as follows: Find the best prices (p₁^{t}, . . . , pₙ^{t}) for the n product items at each time-period “t” over the selling season in a given merchandise category that maximizes the total profits subject to certain constraints, when demand for the i^{th} item at time t is expressed as a given function sᵢ^{t}=ƒᵢ^{t}(p₁^{t}, . . . , pₙ^{t}) (i.e., the “demand model”).

Many real-world optimization problems are formulated to minimize or maximize a nonlinear time-dependent function of discrete variables subject to certain constraints involving that function or some linear functions of its arguments. An example of this problem type is the maximization of some objective function (e.g., the total profits or total revenues) for several merchandise items in a product category where demand for each item is expressed as a nonlinear function of all item prices, which can take values only from specific price ladders (i.e., a set of allowed prices), with the pricing dependent on time periods during the selling season. For example, men's suits may have four distinct selling seasons: Winter, Spring, Summer and Fall, or Graduation season, Wedding season, etc. Seasonality can play large role in some grocery products. For example, pumpkin-related items can have a regular and holiday season, cold beverages can see spike in sales in summer months compared to winter months, etc.

This class of problems is known to be difficult to solve to optimality and even finding a high-quality approximate solution is generally intractable. Since the demand function is typically not assumed to be convex or concave, these problems also are not typically solvable by gradient methods even if the price ladder constraint is relaxed and price variables are considered continuous.

Two known examples of modeling product demand as a function of product prices include the “SCAN*PRO” demand model, disclosed for example in K. Talluri and G. Van Ryzin, “The Theory and Practice of Revenue Management”, Chapter 5, Springer 2005, and the multinomial logit (“MNL”) choice-based demand model disclosed in S. Subramanian and H. Sherali, “A fractional programming approach for retail category price optimization”, Journal of Global Optimization (2010) 48:263-277 (“Subramanian”).

In the SCAN*PRO demand model, the demand for the i^{th} item is expressed as:

$${d}_{i} ( {p}_{1} , … , {p}_{n} ) = {d}_{i}^{0} {\prod }_{j = 1}^{n} {( \frac{{p}_{j}}{{p}_{j}^{0}} )}^{{γ}_{ij}}$$

where dᵢ⁰ is demand at initial prices (p₁⁰, . . . , pₙ⁰).

In the MNL choice-based demand model, the demand is expressed as

$${d}_{i} ( {p}_{1} , … , {p}_{n} ) = \frac{{e}^{{U}_{i} ( {p}_{i} )}}{{\sum }_{j = 1}^{n} {e}^{{U}_{j} ( {p}_{j} )}} θ ( {p}_{1} , … , {p}_{n} )$$

where Uᵢ(pᵢ) is a utility function based on price pᵢ of the i^{th} item and θ(p₁, . . . , pₙ) is the calibration parameter based on all product prices.

In known product pricing optimizers that generate optimized prices, the optimization problem is typically solved by a series of greedy searches, which sometimes delivers a solution far from optimal. Other known approaches are based on linear or quadratic approximations of the nonlinear demand function. However, these approaches tend to suffer from insufficient accuracy (linear approximation) or an overwhelming number of integer variables needed to formulate the problem.

Further, other approaches consider only a single product, as opposed to multiple products with cross effects to be marked down. Other approaches are based on dynamic programming formulations, which result in searching through an extremely large state-space.

In Subramanian, the disclosed algorithm is designed to solve the optimization problem for the MNL-based demand model by relying on transformed variables and a piecewise linear approximation. However, this approach depends on the properties of the specific functional form for demand (i.e., the MNL). The solution to the price optimization problem becomes even more challenging when a time dimension is included.

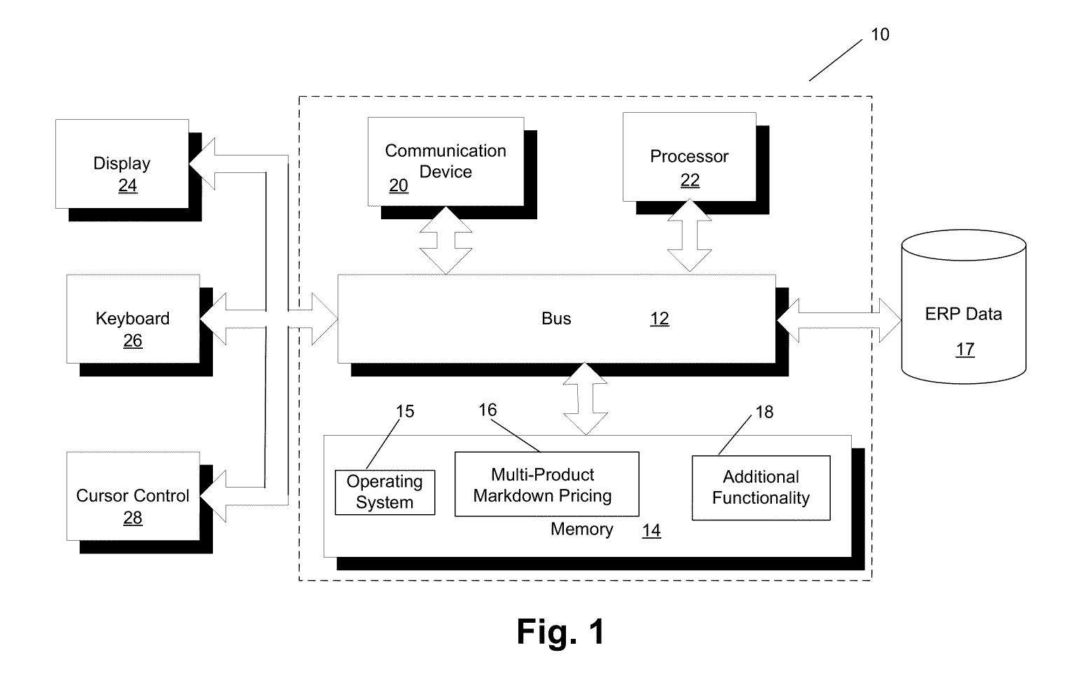

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a multi-product markdown pricing module 16 that generates optimized multi-product markdown pricing, as disclosed in more detail below. System 10 can be part of a larger system, such as an enterprise resource planning (“ERP”) system. Therefore, system 10 will typically include one or more additional functional modules 18 to include the additional functionality. A database 17 is coupled to bus 12 to provide centralized storage for modules 16 and 18 and store pricing information, inventory information, ERP data, etc.

One embodiment obtains a high-quality approximate solution to the multi-product optimization problem by taking advantage of the discrete nature of the variables. Embodiments work for a general class of problems, and is not limited to pricing problems.

In one embodiment, at least the following constraints are considered and utilized:

Demand model: The demand model assumes infinite population with myopic (non-strategic) customers. Further, the model does not account for demand dependency on the previous sales (i.e., the demand in time period t, is only function of prices in period t).

Budget constraints: The budget constraints span several pricing decisions within a specified time period. For example, if the pricing is performed on a weekly basis, the budget constraint may be imposed on a monthly or quarterly basis as follows: Σ_{tεQ}Σᵢ₌₁ⁿΔpᵢₜIᵢₜ≦B_{Q}, where i is the merchandise item index, n is the number of items in the category, t is the pricing decision time index, Q is the markdown budget period, Δpᵢₜ is the markdown price change of item i at time t, and Iᵢₜ is the inventory level.

Sell-through constraints: A sell-through constraint is the constraint that the retailer targets to clear a specified percentage of the inventory, and the unsold inventory at the end of the selling horizon is salvaged or liquidated.

Maximum number of markdowns for multiple products per period: There is a cost associated with implementing a markdown, and therefore the retailer imposes a restriction on how many products can be marked down in a particular period.

Maximum number of markdowns for a specific product till exit date: Retailers impose this restriction as frequent markdowns will cause customers to devalue the current markdown.

Minimum or Maximum markdown depth: The maximum depth of markdown is imposed as some products are dictated by brand image, vendor contracts, etc., and therefore retailers will not be able to take deep discounts. The minimum depth is imposed to make the markdown effective and thus elicit a sufficient lift in the demand from the customers.

Minimum time between consecutive markdowns: The minimum time constraint is that a retailer has to wait until a few time periods before another markdown can be considered. The justification for this includes the cost of implementation and the potential devaluation of the brand image through frequent markdowns.

Different exit dates: An exit date constraint accounts for the shortened lifecycle of some products. This can arise due to various reasons, including varying shelf-life, earlier time of introduction to the market, need to clear inventory for next season, etc.

Embodiments use variables defined as follows:
ƒᵢ^{t}(p₁^{t}, . . . , pₙ^{t}) is a nonlinear time-dependent expression for the i^{th} item demand at time t as a function of all prices in the category at that time period.
   Pᵢ is the price ladder (discrete set) for the i^{th} item.
   Δ is the maximal magnitude of price variations allowed for a single change between two successive prices.
   τᵢ is the minimum time between consecutive price changes for the i^{th} item.
   Bₜ is the budget constraint for time-period t.
   αᵢ is sell-through target for i^{th} item by the end of selling season.
Kᵢ and Nₜ represent the imposed limitations on the number of price changes per item and per time-period respectively.
pᵢ^{t} and bᵢ^{t} are the decision variables. The latter are binary variables that indicate if the price of the i^{th} item at time t is varied.
   Iᵢ^{t} is a decision variable that represents the inventory level of item i at the beginning of time period t.
   Lₚ are the feasible price regions defined by the linear inter-item constraints and other business requirements.

The problem to be solved by embodiments of the present invention can be defined as follows (“equations 1-13”)

$$\begin{matrix}\\ \begin{matrix}{max}_{{p}_{it}} & g ( {p}_{it} , {s}_{it} ) & & Objective as function of price \& sales\end{matrix} & ( equation 1 ) \\ \begin{matrix}s . t . & {d}_{it} = {f}_{it} ( {p}_{1 t} , {p}_{2 t} , … , {p}_{nt} ) & ∀ i ∈ , ∀ t ∈ 𝕋 & Demand as function of price\end{matrix} & ( equation 2 ) \\ \begin{matrix} & {p}_{it}^{min} {b}_{it} \leq {p}_{i , t - 1} - {p}_{i , t} \leq {p}_{it}^{max} {b}_{it} & ∀ i ∈ , ∀ t ∈ 𝕋 & Max . price change\end{matrix} & ( equation 3 ) \\ \begin{matrix} & {\sum }_{k = t}^{min ( t + {τ}_{i} - 1 , T )} {b}_{ik} \leq 1 & ∀ i ∈ , ∀ t ∈ 𝕋 & No touch period\end{matrix} & ( equation 4 ) \\ \begin{matrix} & {\sum }_{i = 1}^{n} {I}_{it} Δ {p}_{it} \leq {B}_{t} & ∀ t ∈ 𝕋 & Max . inventory value drop\end{matrix} & ( equation 5 ) \\ \begin{matrix}\begin{matrix} \\ \end{matrix} & \begin{matrix}{s}_{it} \leq {d}_{it} \\ {s}_{it} \leq {I}_{it - 1}\end{matrix} & \begin{matrix}∀ i ∈ , ∀ t ∈ 𝕋 & Max . sales \\ & \end{matrix}\end{matrix} & ( equation 6 ) \\ \begin{matrix} & {I}_{it} = {I}_{it - 1} - {s}_{it} & ∀ i ∈ , ∀ t ∈ 𝕋 & Inventory balance constraints\end{matrix} & ( equation 7 ) \\ \begin{matrix} & {\sum }_{t = 1}^{T} {b}_{it} \leq {K}_{i} & ∀ i ∈ & Max . number of price change \text{/} item\end{matrix} & ( equation 8 ) \\ \begin{matrix} & {\sum }_{i = 1}^{n} {b}_{it} \leq {N}_{t} & ∀ t ∈ 𝕋 & Max . number of price change \text{/} period\end{matrix} & ( equation 9 ) \\ \begin{matrix} & {\sum }_{t = 1}^{{T}_{i}} {s}_{it} \geq {α}_{i} {I}_{i 0} & ∀ i ∈ & Sell \text{-} through constraints\end{matrix} & ( equation 10 ) \\ \begin{matrix} & {b}_{it} ∈ \{ 0 , 1 \} & ∀ i ∈ , ∀ t ∈ 𝕋 & Indicator of price change\end{matrix} & ( equation 11 ) \\ \begin{matrix} & {p}_{it} ∈ {P}_{i} & ∀ i ∈ , ∀ t ∈ 𝕋 & Price ladder\end{matrix} & ( equation 12 ) \\ \begin{matrix} & ( {p}_{1 t} , {p}_{2 t} , … , {p}_{nt} ) ∈ {L}_{p} & ∀ t ∈ 𝕋 & Feasible price constraints\end{matrix} & ( equation 13 )\end{matrix}$$

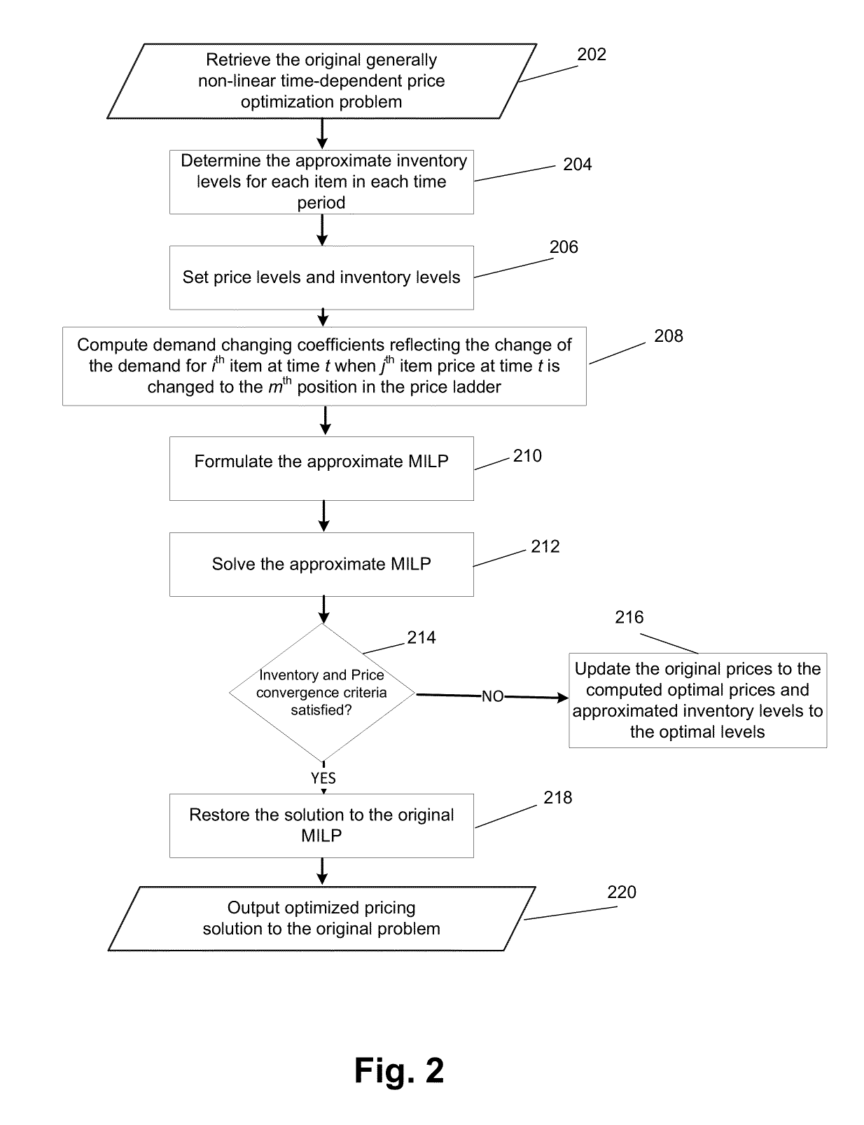

FIG. 2 is a flow diagram of the functionality of multi-product markdown pricing module 16 of FIG. 1 when optimizing multi-product markdown pricing in accordance with one embodiment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, the original, generally non-linear time-dependent price optimization problem is read from the input stream or retrieved from memory. In one embodiment, the time-dependent price optimization problem is the problem disclosed by equations 1-13 above, and includes a demand model. However, other problems/demand models can be used. In one embodiment, the revenue is maximized for several merchandise items in a category, where demand for each item is expressed as a nonlinear function of all item prices, which can take values only from specific price ladders (i.e., a set of allowed prices) with the pricing dependent on timing periods during the selling season. Input parameters can include various complex time-dependent aspects such as maximum number of price changes per period per item and per item constant price period requirements. Initial prices are included as input to the optimization problem. The initial prices are typically specified by the retailer.

At 204, the approximate inventory levels for each item in each time period are determined (i.e., approximate inventory levels for i^{th} item at time t). The trajectory of inventory is assumed to follow a particular functional form with respect to time (e.g., linear form).

At 206, original prices are set to the prices read from the input at 202 or set to optimal values from the previous iteration coming from 216. Similarly, inventory levels are set to computed inventory levels from 204 or optimal levels from the previous iteration coming from 216.

At 208, for every pair of products in a common product category at each time period, the changes in the demand of the first product when the price of the second product is changed from the base (usually initial) level to various other levels in the price ladder of the second product is determined as coefficients. A pair of products may be related products that can be substituted for each other, such as be 2% organic milk and 2% regular milk. The determined coefficients will be usually relatively large when the first and the second products are the same type of products, reflecting strong dependency of product demand on its own price. On the other hand, when the products are different, the corresponding demand changing coefficients are relatively small reflecting relatively weak cross-product effect.

At 210, an approximate Mixed Integer Linear Programming (“MILP”) is formulated, as disclosed in more detail below, where change in demand for any given product at time t is calculated as the sum of the coefficients determined at 208 for the corresponding price setting over all products including the given product. All other constraints of the original problem are linear by definition and do not need to be changed.

At 212, the approximate MILP of 210 is solved using any known MILP solver.

At 214, the prices and inventory levels are checked for convergence criteria. The loop will terminate if the convergence criteria are satisfied and then the functionality continues at 218. In one embodiment, the convergence criteria for inventory can be: compute the absolute difference between approximate inventory levels and the optimal inventory levels and if the error is less than a pre-specified value, convergence criteria for inventory is satisfied. A similar convergence criteria can be used for price levels. Otherwise, the functionality continues at 216.

At 216, optimal values for prices and inventory for each item and time period determined at 212 are used as new starting values for the prices and inventory levels.

At 218, the solution to the original problem is restored from the approximate MILP by setting the price for each product to the one corresponding to the non-zero binary variable. The constraints of the approximate MILP guarantee that for each product only one binary variable indicating the optimal price in the price ladder is set to one while the others are set to zero.

At 220, the pricing solution to the original problem is written to the output stream for reporting and other interface purposes and for determining optimized pricing

### MILP Formulation

In order to formulate the MILP at 210 above, it is assumed that the sales in a given week depend only on the prices of that week, and can be any time-dependent function. Further, it is assumed that the current (potentially infeasible) solution is (p₁⁰, . . . , pₙ⁰) and the objective is to find the new price vector at each time period over the time horizon in the vicinity of the initial solution. However, embodiments are not limited by these assumptions.

First, the demand value at time t is denoted by sᵢ⁰(t) where the initial prices are set (i.e., sᵢ⁰(t)≡ƒᵢ^{t}(p₁⁰, . . . , pₙ⁰)) and the set of coefficients is introduced to express the difference between demand value when only one price is changed and the current demand at time t:

δᵢⱼ^{m}(t)=ƒᵢ^{t}(p₁⁰, . . . ,pⱼ₋₁⁰,pⱼ^{m},pⱼ₊₁⁰, . . . ,pₙ⁰)−sᵢ⁰(t).

Second, binary decision variables xᵢ^{m}(t) are introduced that indicate whether the i^{th} price variable at time t was assigned to the m^{th} price in its ladder:

$${x}_{i}^{m} ( t ) = \{ \begin{matrix}1 & if {p}_{1}^{t} = {p}_{i}^{m} , \\ 0 & otherwise .\end{matrix}$$

Finally, after introducing a similar set of continuous auxiliary variables yᵢ^{m}(t) the following MILP problem is formulated:

$$\begin{matrix}max & {\sum }_{t = 1}^{T} {\sum }_{i = 1}^{n} {\sum }_{m = 1}^{{M}_{i}} {p}_{i}^{m} {s}_{it}^{m} & & \\ s . t . & {\sum }_{m = 1}^{{M}_{i}} {x}_{it}^{m} = 1 & ∀ i ∈ , ∀ t ∈ 𝕋 & 1. Price selection \\ & & ∀ i ∈ , ∀ t ∈ 𝕋 & 2. Price change max . violation \\ & {b}_{i} Δ {p}_{it}^{min} \leq {\sum }_{m = 1}^{{M}_{i}} {p}_{i}^{m} {x}_{i , t - 1}^{m} - {\sum }_{m = 1}^{{M}_{i}} {p}_{i}^{m} {x}_{it}^{m} \leq {b}_{it} \cdot {Δp}_{it}^{max} & & \\ & {\sum }_{k = t}^{min ( t + {τ}_{i} - 1 , T )} {b}_{it} \leq 1 & ∀ i ∈ , ∀ t ∈ 𝕋 & 3. No touch period \\ & {\sum }_{t = 1}^{T} {b}_{it} \leq {K}_{i} & ∀ i ∈ & 4. Max . number of price change \text{/} item \\ & {\sum }_{i = 1}^{n} {b}_{it} \leq {N}_{t} & ∀ t ∈ 𝕋 & 5. Max . number of price change \text{/} period \\ & {\sum }_{i = 1}^{n} {\sum }_{m = 1}^{{M}_{i}} {p}_{i}^{m} ( {q}_{it}^{m} - {\tilde{q}}_{it}^{m} ) \leq {B}_{t} & ∀ t ∈ 𝕋 & \\ & 0 \leq {q}_{it}^{m} \leq {I}_{i 0} {x}_{it}^{m} & & \\ & \begin{matrix}{I}_{it} - ( 1 - {x}_{it}^{m} ) {I}_{0} \leq {q}_{it}^{m} \leq {I}_{it} \\ 0 \leq {\tilde{q}}_{it}^{m} \leq {I}_{i 0} {x}_{it + 1}^{m}\end{matrix} & \begin{matrix}∀ i ∈ , ∀ t ∈ 𝕋 , ∀ m ∈ {𝕄}_{i} \\ ∀ i ∈ , ∀ t ∈ 𝕋 , ∀ m ∈ {𝕄}_{i}\end{matrix} \} & \begin{matrix}6. Linearized max . inventory value drop \\ \end{matrix} \\ & {I}_{it} - ( 1 - {x}_{it + 1}^{m} ) {I}_{0} \leq {\tilde{q}}_{it}^{m} \leq {I}_{it} & & \\ & {\sum }_{m = 1}^{{M}_{i}} {y}_{it}^{m} = {d}_{i}^{0} + {\sum }_{j = 1}^{n} {\sum }_{m = 1}^{{M}_{j}} {δ}_{ijt}^{m} {x}_{jt}^{m} & ∀ i ∈ , ∀ t ∈ 𝕋 & 7. Demand as a function demand change \\ & 0 \leq {y}_{it}^{m} \leq {d}_{it}^{max} {x}_{it}^{m} & ∀ i ∈ , ∀ t ∈ 𝕋 , ∀ m ∈ {𝕄}_{i} & 8. Max . demand per item \\ & {I}_{it} = {I}_{it - 1} - {\sum }_{m ∈ {M}_{i}} {s}_{it}^{m} & ∀ i ∈ , ∀ t ∈ 𝕋 & 9. Inventory balance constraints \\ & {\sum }_{m ∈ {M}_{i}} {s}_{it}^{m} \leq {I}_{it - 1} & & \\ & {s}_{it}^{m} \leq {y}_{it}^{m} & ∀ i ∈ 𝓃 , ∀ t ∈ 𝕋 , ∀ m ∈ {𝕄}_{i} & 10. Maximum Sale \\ & {\sum }_{t = 1}^{{T}_{i}} {\sum }_{m = 1}^{{M}_{i}} {s}_{it}^{m} \geq {α}_{i} {I}_{i 0} & ∀ i ∈ & 11. Sell \text{-} through constraints \\ & {b}_{it} ∈ \{ 0 , 1 \} & ∀ i ∈ , ∀ t ∈ 𝕋 & 12. Indicator of price change \\ & {x}_{it}^{m} ∈ \{ 0 , 1 \} & ∀ i ∈ , ∀ t ∈ 𝕋 , ∀ m ∈ {𝕄}_{i} & 13. Indicator of price selection \\ & ( {\sum }_{m = 1}^{{M}_{1}} {p}_{1}^{m} {x}_{1 t}^{m} , … , {\sum }_{m = 1}^{{M}_{n}} {p}_{n}^{m} {x}_{nt}^{m} ) ∈ {L}_{p} & ∀ t ∈ 𝕋 & 14. Feasible price requirements\end{matrix}$$

As shown, in one embodiment, instead of a general objective function, the total revenue is maximized without discount factor. Further, by using approximate inventory levels it is possible to substitute complex markdown budget constraints in the above formulation with simpler constraints:

$${\sum }_{i = 1}^{n} {\hat{I}}_{it} ( {p}_{it} - {p}_{i , t + 1} ) \leq {B}_{t}$$

where Îᵢₜ is the approximation of inventory level for item i at time t. After each iteration, the inventory level approximation is recomputed at 216 of FIG. 2 using the demand based on the most recent price trajectory.

The solution to the MILP problem serves as an approximation to the exact solution of the original problem of equations 1-13 above. Indeed, it is guaranteed that exactly one xᵢ^{m}(t) variable is equal to one for each item i at each time t, which also implies that only one yᵢ^{m}(t) variable is non-zero. It is also imposed that the non-zero yᵢ^{m}(t) variable is equal to the demand approximation. Finally, the constraints on feasible price (demand and revenue, respectively) regions are similar than the one in the original formulation. The above MILP approximation problem can be solved by any widely available MILP solver within the time frame acceptable for most practical applications.

As disclosed, using the MILP when solving the problem of equations 1-13 above provides a near-optimal solution subject to multiple constraints and non-zero cross-item elasticity. Embodiments provide several advantages compared to known approaches that are based on optimizing individual items.

To demonstrate some advantages, calculations were conducted for sets of eight items with SCAN*PRO demand models using sparse asymmetric elasticity matrices. In a first series of calculations, the total revenue obtained subject only to budget constraints was compared. The known approach used a heuristic based on a multiple choice knapsack optimization on a week-by-week basis. For a given week the known approach computes the markdown cost for the week and revenue for the remaining period based on the previous markdown history. Then, a multiple choice knapsack problem is solved to maximize the total revenue in the remaining period subject to markdown budget for the current week. It was shown that the embodiments of the present invention provide a solution that is approximately 1.5% better than the one obtained by known approaches.

In the other set of calculations, the revenue loss caused by ignoring the cross-elasticity effects is estimated. First, the revenue from the price trajectories obtained by solving the problem with cross-elasticities set to zero is determined. Then, the problem was solved with actual non-zero cross-elasticities. Results demonstrated that in some cases the revenue difference can be as high as 10% using embodiments of the present invention.

In addition to the revenue gains, and in contrast to known approaches, embodiments of the present invention can jointly handle multiple constraints such as a markdown budget, sell-through constraints, and a maximum number of price changes per item and per period. In general, the inability of known approaches to work with sell-through constraints for the inelastic items caused skewed elasticity estimation to force inelastic items to be considered elastic. In addition, embodiments can be fairly easily extended to include such important features as inventory effect.

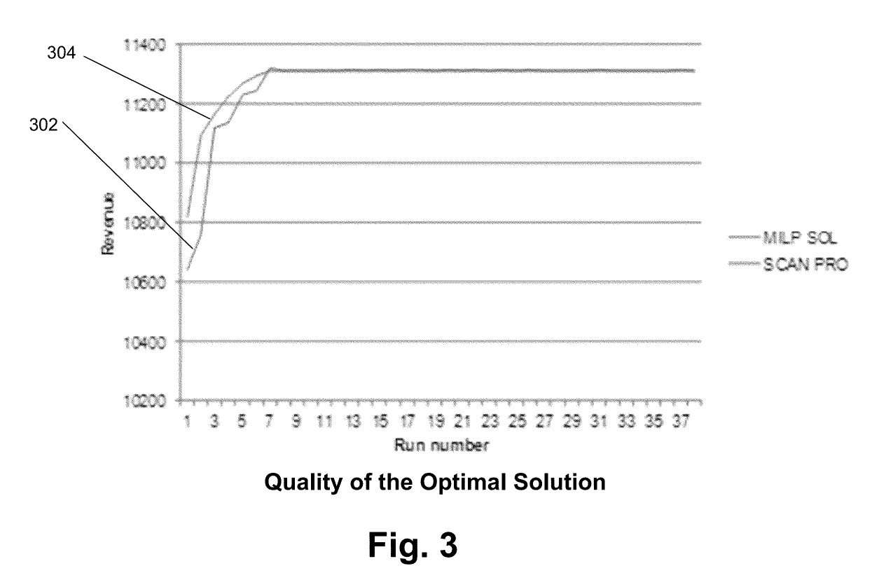

FIG. 3 is a graph of revenue versus run number for optimizers in accordance with embodiments. Curve 302 uses the MILP approximation in accordance with one embodiment, while curve 304 uses the known SCAN*PRO model. As shown, embodiments approach the exact demand model (e.g., the SCAN*PRO model) after very few iterations.

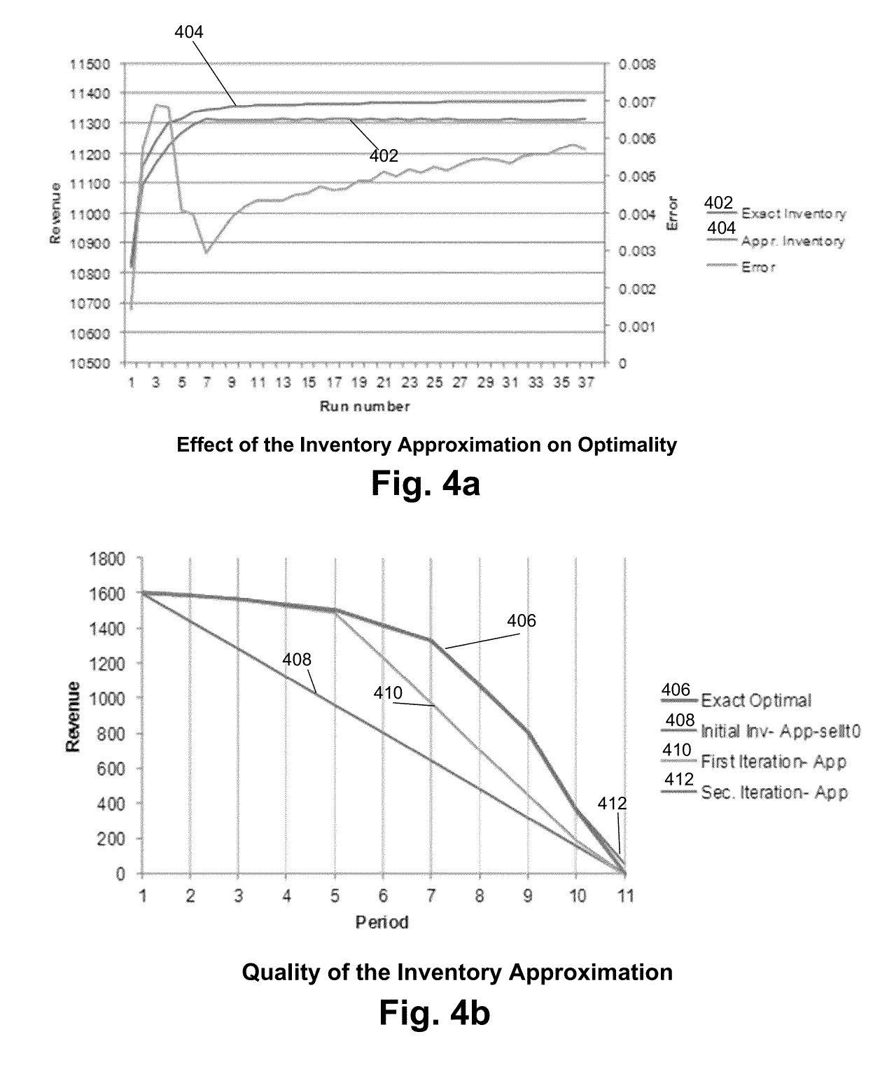

FIGS. 4a and 4b are graphs showing the effect of inventory approximation on optimality and the quality of the inventory approximation, respectively, in accordance with embodiments. As shown in FIG. 4a, the approximate inventory approach in accordance with embodiments of the present invention (curve 404) churns out an approximate optimal solution that is within 0.5% of an optimal solution (curve 402) obtained using an exact inventory approach. As shown in FIG. 4b, it is shown that the final inventory levels/second iteration (curve 412) converge to exact inventory levels (curve 406) quickly, in comparison to the initial inventory (curve 408) and the first iteration (curve 410). This explains why the optimal solution(s) obtained in both the approaches—approximated (using embodiments of the present invention) and exact inventory (using, e.g., the SCAN*PRO model) converge.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, cause the processor to determine markdown product pricing for a plurality of items over a plurality of time periods, the determining comprising:
receiving a non-linear time-dependent problem, wherein the non-linear time-dependent problem comprises a demand model;
determining approximate inventory levels for each item in each time period;
for a plurality of pair of items in a product category, determining coefficients for a change in demand of a first product at each of the plurality of time periods when a price of a second product is changed using initial prices and initial approximate inventory levels;
generating an approximate Mixed Integer Linear Programming (MILP) problem comprising a change of demand based on a sum of the determined coefficients;
solving the MILP problem to generate revised prices and revised inventory levels;
when the generated revised prices and revised inventory levels do not satisfy a convergence criteria after the solving, repeating the determining coefficients, the generating the approximate MILP problem and the solving the MILP problem using the revised prices and the revised inventory levels as the initial prices and initial approximate inventory levels until the convergence criteria is satisfied;
when the convergence criteria is satisfied, assigning the revised prices as the markdown product pricing.

2. The computer readable medium of claim 1, wherein the solving the MILP problem comprises setting a solved price of each item to a non-zero binary variable.

3. The computer readable medium of claim 1, wherein the non-linear time-dependent problem comprises assigning prices on items from a price ladder.

4. The computer readable medium of claim 1, wherein the non-linear time-dependent problem comprises one or more time-dependent constraints.

5. The computer readable medium of claim 4, wherein the time-dependent constraints comprise at least one of: a maximum number of price changes per item and per time period, a minimum time between consecutive markdowns or a minimum or maximum markdown depth.

6. The computer readable medium of claim 4, wherein the time-dependent constraints comprise a markdown budget.

7. A computer implemented method for determining markdown product pricing for a plurality of items over a plurality of time periods, the method comprising:
receiving a non-linear time-dependent problem, wherein the non-linear time-dependent problem comprises a demand model;
determining approximate inventory levels for each item in each time period;
for a plurality of pair of items in a product category, determining coefficients for a change in demand of a first product at each of the plurality of time periods when a price of a second product is changed using initial prices and initial approximate inventory levels;
generating an approximate Mixed Integer Linear Programming (MILP) problem comprising a change of demand based on a sum of the determined coefficients;
solving the MILP problem to generate revised prices and revised inventory levels;
when the generated revised prices and revised inventory levels do not satisfy a convergence criteria after the solving, repeating the determining coefficients, the generating the approximate MILP problem and the solving the MILP problem using the revised prices and the revised inventory levels as the initial prices and initial approximate inventory levels until the convergence criteria is satisfied;
when the convergence criteria is satisfied, assigning the revised prices as the markdown product pricing.

8. The method of claim 7, wherein the solving the MILP problem comprises setting a solved price of each item to a non-zero binary variable.

9. The method of claim 7, wherein the non-linear time-dependent problem comprises assigning prices on items from a price ladder.

10. The method of claim 7, wherein the non-linear time-dependent problem comprises one or more time-dependent constraints.

11. The method of claim 10, wherein the time-dependent constraints comprise at least one of: a maximum number of price changes per item and per time period, a minimum time between consecutive markdowns or a minimum or maximum markdown depth.

12. The method of claim 10, wherein the time-dependent constraints comprise a markdown budget.

13. A markdown product pricing system that determines markdown pricing for a plurality of items over a plurality of time periods, the system comprising:
a demand coefficient module that receives a non-linear time-dependent problem, wherein the non-linear time-dependent problem comprises a demand model, determines approximate inventory levels for each item in each time period and for a plurality of pair of items in a product category, determines coefficients for a change in demand of a first product at each of the plurality of time periods when a price of a second product is changed using initial prices and initial approximate inventory levels;
a Mixed Integer Linear Programming (MILP) module that generates an approximate MILP problem comprising a change of demand based on a sum of the determined coefficients and solves the MILP problem to generate revised prices and revised inventory levels;
a convergence module that when the generated revised prices and revised inventory levels do not satisfy a convergence criteria after the solving, causes the demand coefficient module and the MILP module to repeat the determining coefficients, the generate the approximate MILP problem and the solve the MILP problem using the revised prices and the revised inventory levels as the initial prices and initial approximate inventory levels until the convergence criteria is satisfied;
wherein the convergence module, when the convergence criteria is satisfied, assigns the revised prices as the markdown product pricing.

14. The system of claim 13, wherein the solving the MILP problem comprises setting a solved price of each item to a non-zero binary variable.

15. The system of claim 13, wherein the non-linear time-dependent problem comprises assigning prices on items from a price ladder.

16. The system of claim 13, wherein the non-linear time-dependent problem comprises one or more time-dependent constraints.

17. The system of claim 16, wherein the time-dependent constraints comprise at least one of: a maximum number of price changes per item and per time period, a minimum time between consecutive markdowns or a minimum or maximum markdown depth.

18. The system of claim 16, wherein the time-dependent constraints comprise a markdown budget.
